(19) United States
(12) Patent Application Publication
(10) Pub. No.: US 2012/0171045 A1
(43) Pub. Date: Jul. 5, 2012

(54) TURBINE COMPONENT FIXTURE AND COATING SYSTEM

(75) Inventors: Brandon W. Spangler, Vernon, CT (US); Lawrence J. Willey, East Hampton, CT (US)

(73) Assignee: UNITED TECHNOLOGIES CORPORATION, Hartford, CT (US)

(21) Appl. No.: 12/983,635

(22) Filed: Jan. 3, 2011

(51) Int. Cl. F01D 5/14; B23P 17/00

(52) U.S. Cl. 416/241 R; 29/888

(57) ABSTRACT

A system comprises a turbine component and a fixture. The turbine component comprises a first end, a second end, a first region with a first feature and a second region with a second feature. The fixture comprises first and second end blocks adjacent the first and second ends of the turbine component, and a load beam coupling the first and second end blocks to retain the turbine component therebetween. A compliant mask is positioned against the turbine component, covering the first region and leaving the second region uncovered. A removable coating is applied to the turbine component, coating the second feature and leaving the first feature uncoated.

### BACKGROUND

This invention relates generally to workpiece fixtures, and specifically to fixtures for turbomachinery components. In particular, the invention concerns a workpiece fixture for gas turbine engine components, including rotor blade and stator vane airfoils.

Gas turbine engines include a variety of rotary-type internal combustion engines and combustion turbines, with applications in industrial power generation, aviation and transportation. The core of the gas turbine engine typically comprises a compressor, a combustor and a turbine, which are arranged in flow series with an upstream inlet and downstream exhaust. Incoming air is compressed in the compressor and mixed with fuel in the combustor, then ignited to generate hot combustion gas. The turbine generates rotational energy from the hot combustion gas, and cooler, expanded combustion products are exhausted downstream.

The compressor and turbine sections are usually arranged into one or more differentially rotating spools. The spools are further divided into stages, or alternating rows of blades and vanes. The blades and vanes generally have airfoil-shaped cross sections, which are designed to accelerate, turn and compress the working fluid flow, and to generate lift that is converted to rotational energy in the turbine.

In industrial gas turbines, power is delivered via an output shaft coupled to an electrical generator or other load, typically utilizing an external gearbox. Other configurations include turbofan, turboprop, turbojet and turboshaft engines for fixed-wing aircraft and helicopters, and specialized turbine engines for marine and land-based transportation, including naval vessels, trains and armored vehicles.

In turboprop and turboshaft engines the turbine drives a propeller or rotor, typically using a reduction gearbox to control blade speed. Turbojets generate thrust primarily from the exhaust, while turbofans drive a fan to accelerate flow around the engine core. Commercial turbofans are usually ducted, but unducted designs are also known. Some turbofans also utilize a geared drive to provide greater fan speed control, for example to reduce noise and increase engine efficiency, or to increase or decrease specific thrust.

Aviation turbines generally have two or three-spool configurations, with a corresponding number of coaxially rotating turbine and compressor sections. In two-spool designs the high pressure turbine drives a high pressure compressor, forming the high pressure spool or high spool. The low spool drives the fan or a propeller or rotor shaft, and may include one or more low pressure compressor stages. Aviation turbines also power auxiliary devices including electrical generators, hydraulic pumps and components of the environmental control system, either via an accessory gearbox using bleed air from the compressor.

In high-bypass turbofans, most of the thrust is generated by the fan. Variable-area nozzle surfaces can be deployed to regulate the bypass pressure and improve fan performance, particularly during takeoff and landing. Low-bypass turbofans provide greater specific thrust but are louder and less fuel efficient, and are more common on military jets and other high-performance aircraft. Low-bypass turbofans generally have variable-area nozzle systems to regulate exhaust speed and specific thrust, and military jets typically include afterburner assemblies for short-term thrust augmentation.

In general, gas turbine engine performance is constrained by the need for higher compression ratios and combustion temperatures, which increase efficiency and output, versus the cost of increased wear and tear on turbine components, including blades, struts and vanes, and the associated airfoil, platform and shroud surfaces. These tradeoffs are particularly relevant in the turbine stages downstream of the combustor, where gas path temperatures are elevated and active cooling is employed.

To increase dependability and service life, each step in the manufacturing process should therefore be uniformly controlled and efficiently performed. Fixture design plays a substantial role in this arena, from initial component machining to final part testing and certification.

### SUMMARY

This invention concerns a fixture system for a turbine component. The fixture comprises first and second end blocks, a load beam, and a compliant mask. The turbine component comprises first and second ends, and first and second regions having different surface or cooling features.

The first and second end blocks are positioned adjacent the first and second ends of the turbine component, and coupled together with the load beam to retain the component therebetween. The compliant mask is positioned to cover the first region of the turbine component, leaving the second region uncovered. A removable coating is applied to coat the surface or cooling features in the second region, leaving the first region uncoated.

### BRIEF DESCRIPTION OF THE DRAWINGS

FIG. 1 is an exploded view of a fixture system for a turbine component.

FIG. 2 is an assembled view of the fixture system, with a compliant mask applied to the turbine component.

FIG. 3A is a perspective view of the fixture system, illustrating a coating process.

FIG. 3B is an exploded view of the fixture system, showing the coating on the turbine component.

FIG. 4 is a perspective view of a fixture system with multiple compliant masks.

FIG. 5 is perspective view of a fixture system with an unshrouded turbine component.

FIG. 6 is an exploded view of a fixture system with locating posts.

FIG. 7 is an assembled view of the fixture system with locating posts.

### DETAILED DESCRIPTION

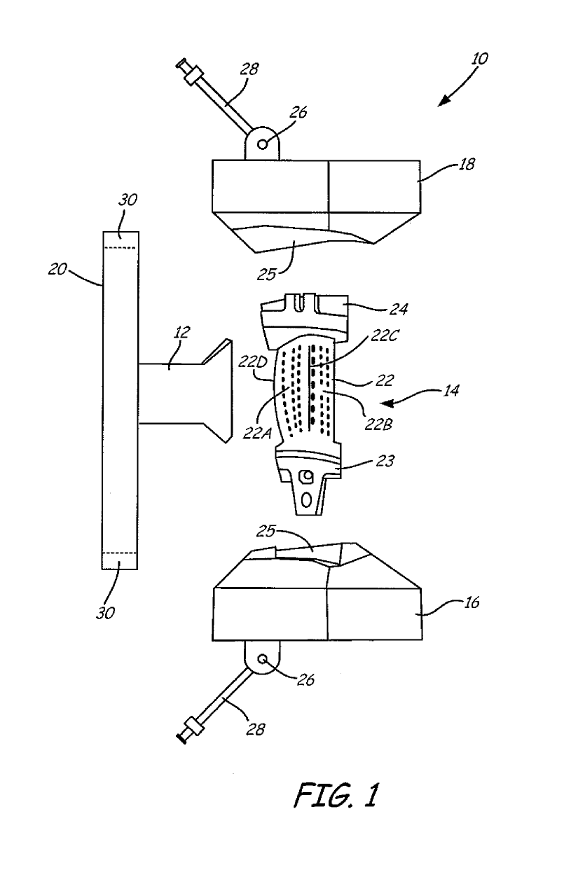

FIG. 1 is an exploded view of fixture system 10 with compliant mask 12 for turbine component 14. Fixture system 10 comprises first end block 16, second end block 18 and load beam 20. Turbine component 14 is positioned between end blocks 16 and 18, and compliant mask 12 is positioned between load beam 20 and turbine component 14.

As shown in FIG. 1, turbine component 14 comprises blade, vane or strut airfoil 22 with first end (or root portion) 23 and second end (or tip portion) 24. Concave (pressure) surface 22A and convex (suction) surface 22B extend from leading edge 22C to trailing edge 22D of airfoil 22.

Turbine component 14 is typically manufactured of a durable, high temperature material such as a nickel or cobalt alloy or superalloy. In the particular embodiment of FIG. 1, first (root) end 23 comprises a platform and attachment structure, and second (tip) end 24 comprises a shroud and sealing structure.

Compliant mask 12 is formed of a flexible, pliant, elastic material such as natural or synthetic rubber, or another suitably pliable or compliant composite or polymer material. Compliant mask 12 is positioned to cover a selected region of cooling holes or other features on turbine component 14, leaving a second region uncovered for application of a wax coating or other removable coating material. The coating material provides for airflow testing and other selective processing steps, with compliant mask 12 to improve the speed, reliability and efficiency of these steps as described below.

First and second end blocks 16 and 18 are formed of a rigid, high strength polymer material such as nylon, or another suitably rigid polymer or composite material. End blocks 16 and 18 comprise lands 25 for sealing and retaining ends 23 and 24 of turbine component 14, and coupling structures 26 and 28 for connecting to load beam 20.

Lands 25 have recessed, flush and protruding embodiments, as configured for sealing engagement with first and second ends 23 and 24 of turbine component 14. In particular, lands 25 accommodate blade, vane and strut embodiments of component 14, and shrouded and unshrouded embodiments of first (root) end 23 and second (tip) end 24.

Load beam 20 is formed of a rigid, high strength polymer material such as nylon, or another suitably rigid polymer or composite material. Slots, holes or other coupling structures are provided to receive fasteners 28 in ends 30 of load beam 20, forming mechanical attachments to end blocks 16 and 18. As shown in FIG. 1, coupling structures 26 and 28 comprise nut and bolt combinations or other threaded fasteners 28, which are connected to end blocks 16 and 18 at pivots 26.

Depending on embodiment, turbine component 14 may comprise a rotor blade, stator vane, guide vane or strut component, with or without airfoil surfaces 22A-22D and the platform and shroud structures at first and second ends 23 and 24. One or more protective coatings may also be applied, for example a thermal barrier coating, an abrasive coating, a hard coating to protect against impacts, or a protective sheath. In further embodiments, turbine component 14 may be made from an aluminum or titanium alloy, or a composite material.

End blocks 16, 18 and load beam 20 may also be formed of different materials. Suitable materials include, but are not limited to, plastics and thermoplastics such as nylon, rigid fluoropolymers, acetal polymers, polyacetal plastics and polyformaldehyde plastics, including Teflon® and Delrin®, which are trade names of E.I. du Pont de Nemours & Co. of Wilmington, Del. Composite materials are also used, for example an adhesive matrix impregnated with a fibrous material such as Kevlar®, which is also available from DuPont, or a carbon fiber matt or other fibrous material embedded in a matrix substrate. Some of these materials also have suitably flexible and pliable forms for use in compliant mask 12.

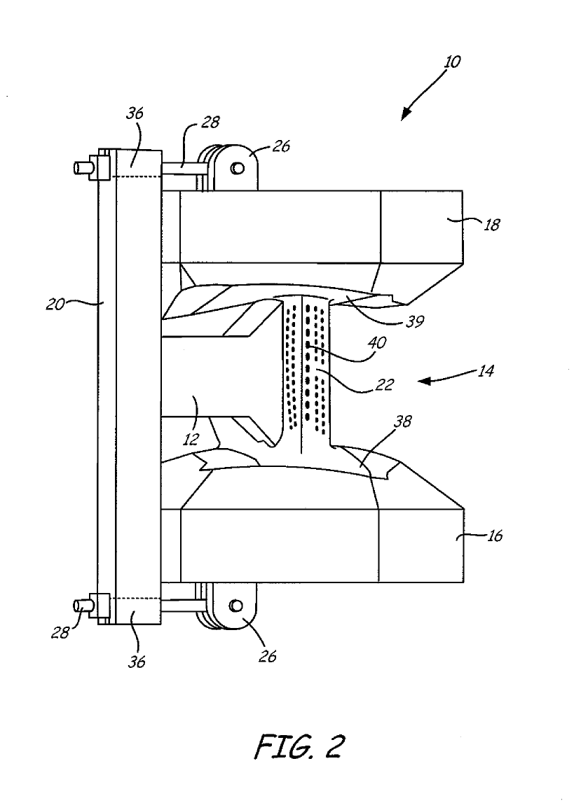

FIG. 2 is an assembled view of fixture system 10 as shown in FIG. 1. Turbine component 14 is positioned between end blocks 16 and 18, with are coupled together with load beam 20 to retain component 14 therebetween. Compliant mask 12 is positioned against the exterior surface of turbine component 14, covering features 40 in a selected region.

As shown in FIG. 2, turbine component 14 comprises airfoil 22 with platform 38 and shroud 39 on the first and second ends. First end block 16 abuts turbine component 14 toward the root portion (first end), sealing against platform 38. Second end block 18 abuts airfoil 22 toward the tip portion (second end), sealing against shroud 39.

First and second end blocks 16 and 18 are attached to load beam 20 by fitting mechanical fasteners 28 into holes or slots 36, and adjusting pivots 26 to retain and seal turbine component 14 between end blocks 16 and 18. Compliant mask 12 is positioned between load beam 20 and turbine component 14, and load beam 20 seals compliant mask 12 against the selected surface of airfoil 22. Scratching, abrasion and other effects on turbine component 14 are reduced by the relatively soft polymer or composite composition of compliant mask 12, end blocks 16 and 18, and load beam 20.

Features 40 comprise film cooling holes and other surface or flow features, which are formed into or onto the different exterior regions and surfaces of airfoil 22, platform 38 and shroud 39. As illustrated in FIG. 2, flow features 40 include round, elliptical, and oblong holes, slots, showerhead openings, weep apertures and other openings or flow features. Features 40 also encompass cooling flow, cross-flow, cross-bleed and vent features, and other surface features for cooling of or modifying the flow over any surface of turbine component 14.

In cooled embodiments, turbine component 14 may comprise a turbine blade, turbine vane or hot strut component configured for a high temperature or high pressure turbine or compressor section of a gas turbine engine. Alternatively, turbine component 14 comprises a blade, vane or strut component for a lower temperature or lower pressure compressor, or a component for the fan section of a turbofan engine.

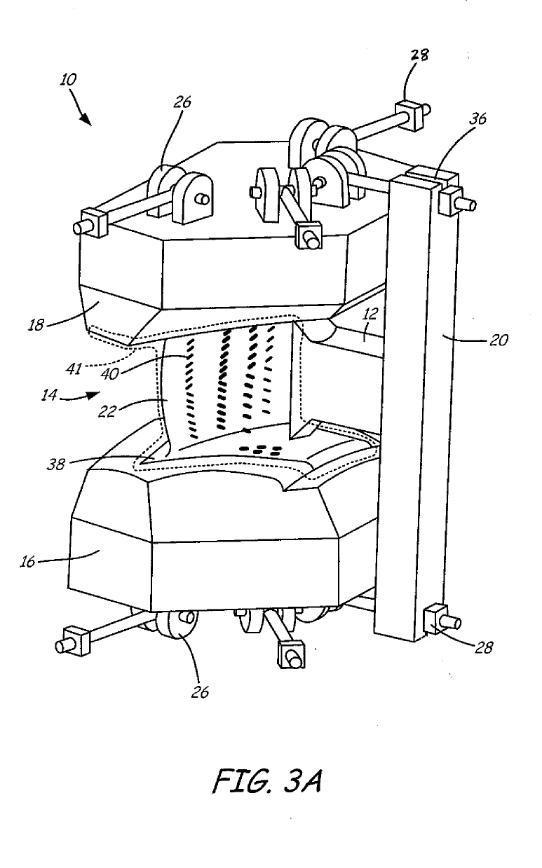

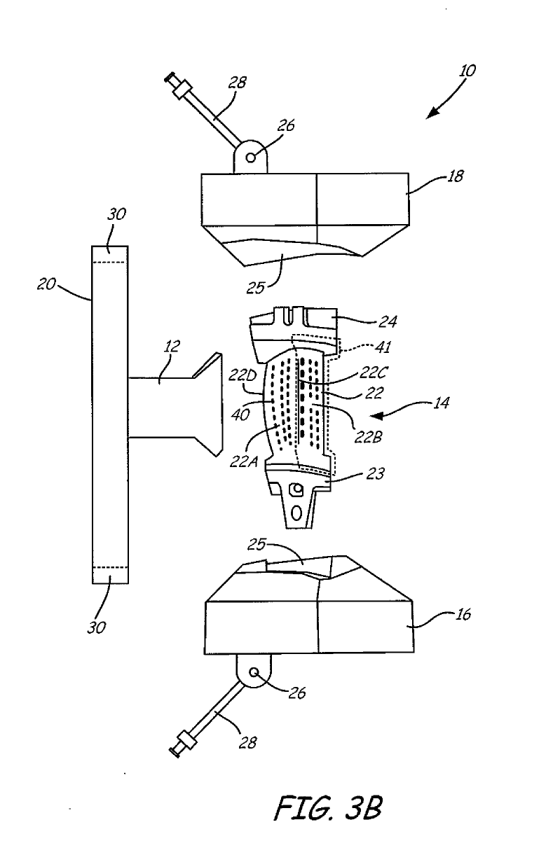

FIG. 3A is a front perspective view of fixture system 10, illustrating a selective coating process for turbine component 14. Load beam 20 couples end blocks 16 and 18 together, retaining turbine component 14 therebetween. Load beam 20 also positions compliant mask 12 against turbine component 14, covering features 40 in a selected region of airfoil 22.

Coating 41 comprises a wax coating or other removable material applied to selected surface of turbine component 14, for example by dipping fixture system 10 in a coating reservoir, or by pouring or brushing on the coating material. Coating 41 coats some or all of the uncovered regions of turbine component 14, including uncovered features 40 on unmasked surfaces of airfoil 22. Coating 41 is not applied to the regions of turbine component 14 covered by compliant mask 12, where mask 12 seals off particular features 40 to prevent contact with the coating material, leaving features 40 uncoated in the selected regions.

In the particular embodiment of FIG. 3A, compliant mask 12 covers selected features 40 along the leading edge of airfoil 22. Coating 41 covers exposed (unmasked) features 40 on the suction and pressure surfaces, along the trailing edge of airfoil 22, and on platform 38. Depending on application method, coating 41 may also cover additional surfaces or components of fixture system 10, including compliant mask 12 adjacent the selected leading edge region of airfoil 22, and end blocks 16 and 18 adjacent platform 38 or similar shroud surface. Features 40 remain uncoated beneath mask 12, in order to accommodate flow testing and other selective processing.

Turbine components 14 are generally high value, high precision parts, and individual testing is time intensive. In particular, misapplication of coating 41 reduces efficiency by increasing the error and rework rates, decreasing reliability and throughput, and raising individual part costs.

Fixture system 10 addresses these problems by utilizing compliant mask 12 to increase precision and repeatability of the coating process, improving quality and reliability while reducing manufacturing time and cost. Compliant mask 12 reduces the need for precision brushed-on coating methods by consistently covering the same features 40 in each selected region, even when other (unselected) features 40 are closely spaced. Faster dip and pour coating methods can also be employed, using a recycling reservoir to reduce waste and environmental impact. Dip and pour coating methods can also employ a wider range of coating materials, including natural waxes with different viscosities and lower melting temperatures, and polymer waxes and coatings with better adhesion, reduced thickness, and other desirable properties.

FIG. 3B is an exploded view of fixture system 10, showing removable coating 41 on turbine component 14. After coating 41 is applied, compliant mask 12 and the other fixture components are removed to expose selected features 40 for additional processing.

In this particular embodiment, selected features 40 remain uncoated along pressure surface 22A and trailing edge 22D, where they were covered by compliant mask 12. Coating 41 covers exposed features 40 along suction surface 22B and at leading edge 22C, in the regions that were not covered by compliant mask 12.

Coating 41 comprises a polymer material such as a natural or polymer wax, as described above, which is removable by heating turbine component 14. Soluble waxes and polymer coatings are also utilized, where coating 41 is removed by washing in water, or by application of a suitable chemical agent such as tolulene.

Use of removable coating 41 provides for more efficient flow testing and other selective processing of turbine component 14. In particular, some components 14 are subject to complex machining steps and coating processes, which can result in over or under drilling, or produce full or partial flow blockages.

Removable coating 41 allows these faults to be detected by coating and closing off particular features 40, while selected features 40 are covered by compliant mask 12. Mask 12 is then removed to measure the flow through or across selected features 40, and individual turbine components 14 are identified for additional inspection, repair, reprocessing or scrap based on the flow rate.

In particular, individual turbine components 14 are identified based on whether the flow falls within a nominal range, or is atypically high or low. Higher flow rates tend to indicate increased flow through over-drilled or over-machined features 40, while lower flow rates indicate decreased flow through under-drilled, under-machined or partially or completely blocked features 40. Fixture 10 and turbine component 14 are then heated or washed to remove coating 41, and the process is repeated in other regions of interest.

Use of a removable wax or polymer material reduces the melting point or solubility temperature at which coating 41 is removed, allowing for repeated testing with lower processing time and reduced risk of damage to fixture 10 and component 14. In particular, the removal temperature is substantially below the operating temperature of turbine component 14. The removal temperature is also substantially below the temperature at which melting, high-temperature oxidation and other phase transitions occur in particular turbine materials, including, but not limited to, nickel and cobalt alloys, superalloys, thermal barrier coatings, abrasive coatings, and aluminum, titanium and composite turbine blade and sheathing materials.

In some embodiments, the melting or wash removal temperature of coating 41 is less than 100° C., for example about 45° to about 85° C. In additional embodiments, coating 41 is removed at room temperature, for example about 20-30° C. or less, for example via a low-temperature wax melting process or by washing with water or a suitable chemical agent.

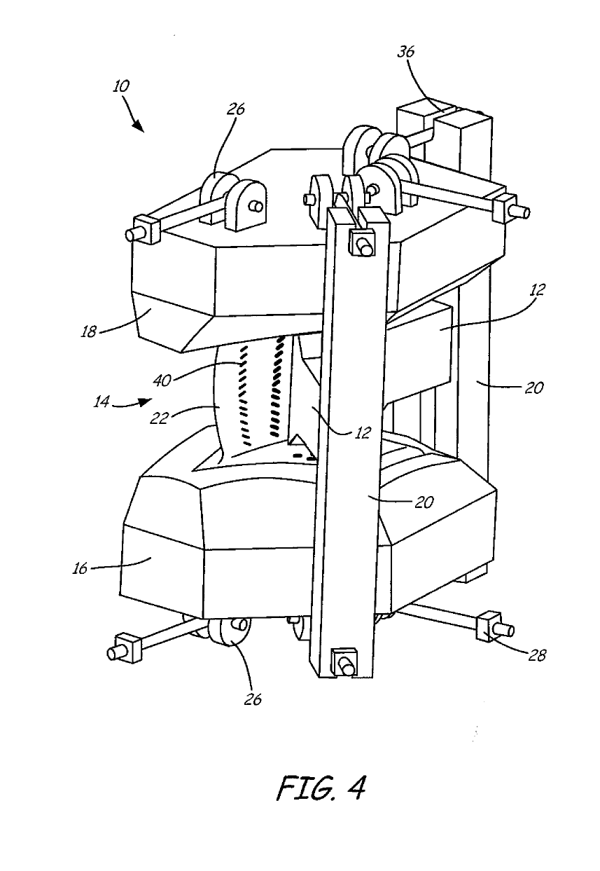

FIG. 4 is a perspective view of fixture system 10 with two or more compliant masks 12 positioned against turbine component 14. This configuration allows features 40 to be selected from among different surfaces of airfoil 22, for example the pressure or suction surface and the leading edge surface, as shown in FIG. 4. Additional coupling structures 26 and 28 are provided to position load beams 20 in other locations with respect to end blocks 16 and 18, with compliant masks 12 covering additional selected surfaces or regions of turbine component 14.

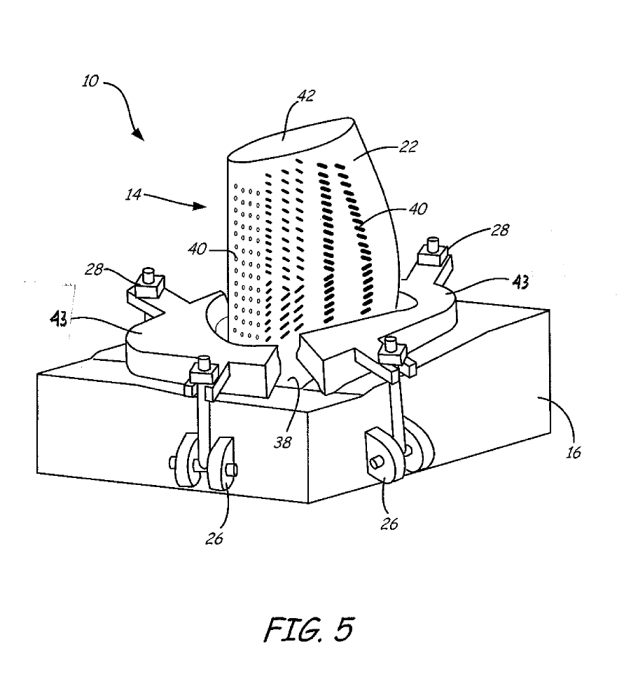

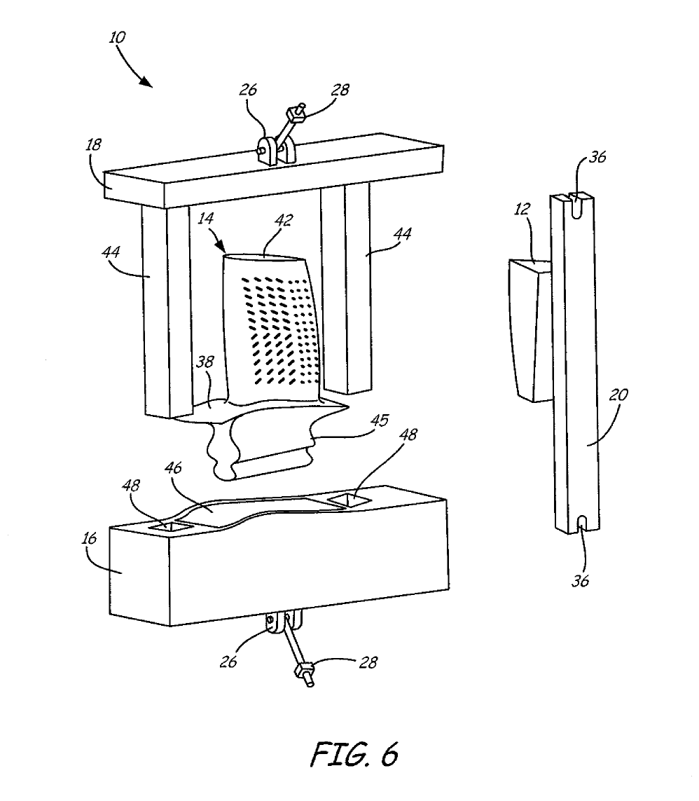

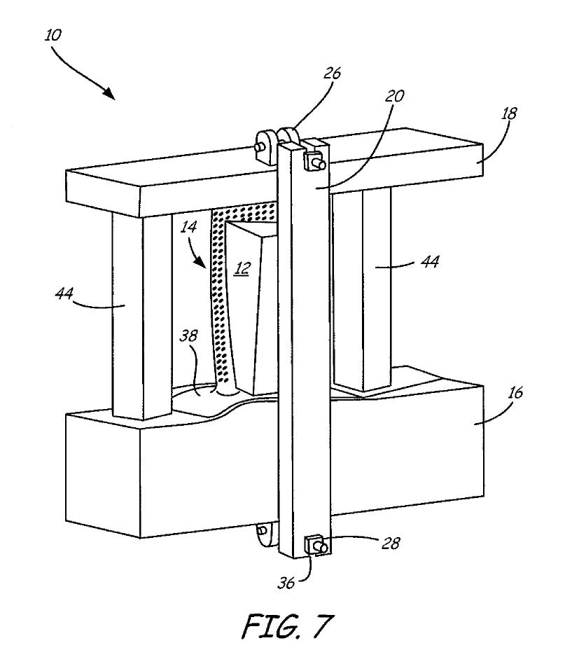

FIG. 5 is view of fixture system 10 with turbine component 14 comprising an unshrouded blade or vane airfoil 22. In this embodiment, airfoil 22 extends upward from the root portion at first end block 16, where the load beam and second (top) end block have been removed to show unshrouded tip 42. When fixture system 10 is assembled, airfoil tip 42 is engaged in sealing relationship with a land on the top end block, as described below with respect to FIGS. 6 and 7.

In the particular embodiment of FIG. 5, compliant masks 43 are positioned to cover selected surface regions of platform 38. Depending on configuration, platform 38 comprises either an inner diameter (ID) flow boundary, for example in a rotor-mounted blade configuration, or an outer (OD) flow boundary, for example in a cantilevered stator vane configuration. Equivalently, compliant masks 43 are positioned to cover selected surfaces on an ID or OD shroud.

As shown in FIG. 5, coupling structures 26 and 28 seal compliant masks 43 against the selected shroud or platform surfaces. This prevents contact with the coating material, so that features 40 remain uncoated in the selected region of turbine component 14, while features 40 in exposed regions are coated. Compliant masks 43 are then removed for flow testing, part identification and other selective processing steps, as described above.

FIG. 6 is an exploded view of fixture system 10 with locating posts 44. In this particular embodiment, blade attachment 45 is located in sealing engagement with recessed land 46 in first (bottom) end block 16, below platform 38. Locating posts 44 are positioned in locator holes 48, which are formed in one or both of first and second end blocks 16 and 18.

FIG. 7 is an assembled view of fixture system 10 as shown in FIG. 6. Locating posts 44 and locating holes 48 cooperate to position second (top) end block 18 with respect to turbine component 14, forming a sealing engagement with blade tip 42 at a flush land on the inside surface of end block 18. Load beam 20 is coupled to end blocks 16 and 18 with fasteners 28, which rotate in pivots 26 to engage in slots 36. Compliant mask 12 is positioned against a selected region of turbine component 14, sealing selected features 40 to prevent contact with the coating material, while exposed features 40 are coated with a wax or other removable coating material.

While this invention has been described with reference to exemplary embodiments, it will be understood by those skilled in the art that various changes may be made and equivalents may be substituted without departing from the scope of the invention. In addition, modifications may be made to adapt particular situations or materials to the teachings of the invention, without departing from the essential scope thereof. The invention is not limited to the particular embodiments disclosed herein, but includes all embodiments falling within the scope of the appended claims.

1. A system comprising:
a turbine component comprising a first end, a second end, a first region comprising a first feature and a second region comprising a second feature;
a first end block adjacent the turbine component at the first end;
a second end block adjacent the turbine component at the second end;
a load beam coupling the first end block to the second end block, wherein the turbine component is retained therebetween;
a compliant mask positioned against the turbine component, wherein the compliant mask covers the first region and the second region is uncovered; and
a removable coating on the turbine component, wherein the removable coating coats the second feature and the first feature is uncoated.

2. The system of claim 1, wherein the removable coating has a melting temperature of less than 100° C.

3. The system of claim 1, wherein the removable coating comprise a water soluble wax material.

4. The system of claim 1, wherein the first feature comprises a cooling hole formed in the first region and the second feature comprises a cooling hole formed in the second region.

5. The system of claim 4, wherein the removable coating coats the second region such that the second cooling hole is closed off, and wherein the compliant mask covers the first region such that the first cooling hole is uncoated.

6. The system of claim 1, wherein the first end of the turbine component comprises a platform and wherein the first end block comprises a recessed land for sealing against the platform.

7. The system of claim 1, wherein the second end of the turbine component comprises tip region and wherein the second end block comprises a land for sealing against the tip region.

8. The system of claim 1, wherein the turbine component comprises an airfoil.

9. The system of claim 8, wherein the first region is selected from the group consisting of a pressure surface, a suction surface, a leading edge surface and a trailing edge surface, and wherein the first feature comprises a hole formed in the selected surface.

10. The system of claim 8, wherein the first region comprises a platform surface or a shroud surface, and wherein the first feature comprises a hole formed therein.

11. A fixture system comprising:
an airfoil comprising a first end, a second end, a first region comprising a first flow feature and a second region comprising a second flow feature;
a first end block positioned against the airfoil at the first end;
a second end block positioned against the airfoil at the second end;
a load beam for coupling the first end block to the second end block, wherein the airfoil is retained therebetween; and
a compliant mask positioned against the airfoil, wherein the compliant mask covers the first region and the second region is exposed; and
a removable polymer coating on the airfoil, wherein the removable polymer coating coats the second flow feature and the first flow feature is uncoated.

12. The fixture system of claim 11, wherein the removable polymer coating comprises a wax material with a melting temperature of less than 100° C.

13. The fixture system of claim 11, wherein the removable polymer coating comprises a soluble wax material.

14. The fixture system of claim 11, wherein the first feature comprises a hole formed in the first region.

15. The fixture system of claim 14, wherein the first region is selected from the group consisting of a pressure surface, a suction surface, a leading edge surface and a trailing edge surface, and wherein the hole is formed in the selected surface.

16. The fixture system of claim 14, wherein the first region comprises a platform surface or a shroud surface, and wherein the hole is formed therein.

17. A method comprising:
positioning a turbine component between first and second end blocks, the turbine component having a first surface with a first hole formed therein, and a second surface with a second hole formed therein;
coupling the first and second end blocks to a load beam, wherein the turbine component is retained between the first and second end blocks;
positioning a compliant mask against the turbine component, wherein the compliant mask covers the first surface and the second surface is exposed; and
applying a removable wax coating to the turbine component, wherein the removable wax coating coats the second hole in the second surface and the first hole is uncoated in the first surface.

18. The method of claim 17, further comprising removing the compliant mask from the first region and testing a flow rate through the first hole.

19. The method of claim 17, wherein applying the removable wax coating comprises dipping the turbine component into a wax material or pouring the wax material onto the turbine component.

20. The method of claim 17, further comprising removing the wax coating at a temperature of less than 100° C.
